(19) United States
(12) Patent Application Publication
(10) Pub. No.: US 2018/0015943 A1
(43) Pub. Date: Jan. 18, 2018

(54) DEVICE FOR INTRODUCING AN AUXILIARY TORQUE INTO A STEERING SHAFT

(71) Applicants: THYSSENKRUPP PRESTA AG, Eschen (LI); thyssenkrupp AG, Essen (DE)

(72) Inventors: Csaba HEGEDÜS, Karancslapujtô (HU); Balint KATONA, Buchs (CH)

(73) Assignees: THYSSENKRUPP PRESTA AG, Eschen (LI); thyssenkrupp AG, Essen (DE)

(21) Appl. No.: 15/547,551

(22) PCT Filed: Dec. 22, 2015
(86) PCT No.: PCT/EP2015/080941

§ 371 Date: Jul. 31, 2017

(30) Foreign Application Priority Data
Feb. 4, 2015 (DE) 10 2015 201 938.1

(51) Int. Cl. B62D 5/04; B62D 3/12; F16D 3/12; F16H 55/24

(52) U.S. Cl. CPC B62D 5/0409; F16H 55/24; B62D 3/12; B62D 5/0403; F16D 3/12

(57) ABSTRACT

A device for introducing an auxiliary torque into a steering shaft of an electromechanical power-assisted steering system may include an electric motor that comprises a motor shaft that is coupled fixedly in terms of torque by means of a coupling element to a gearwheel. The gearwheel may mesh with a toothed wheel disposed rotationally conjointly on the steering shaft. To provide an improved coupling between electric motor and gearwheel with relatively low outlay in terms of production and costs, the coupling element may comprise a torsional elastic bar that is torsionally more flexible than the motor shaft and the gearwheel.

### PRIOR ART

The invention relates to a device for introducing an auxiliary torque into a steering shaft of an electromechanical power-assisted steering system, having an electric motor which comprises a motor shaft which is coupled fixedly in terms of torque by means of a coupling element to a gearwheel which meshes with a toothed wheel arranged rotationally conjointly on the steering shaft.

In the prior art, motor vehicle steering systems with power assistance means are known in the case of which, in addition to the steering moment exerted on the steering wheel manually by the driver, an auxiliary force for assisting and reducing the burden on the driver is introduced into the steering train by means of an electromechanical power assistance means, with an additional steering angle possibly also being introduced. The assistance force to be introduced is determined on the basis of the torque, that is to say the magnitude of the steering moment, which is introduced into the steering-wheel-side part of the steering shaft, the input shaft, and introduced into the steering gear via the output shaft connected to the input shaft. In the steering gear, the rotational movement of the steering shaft is converted into a displacement of the track bars and is transmitted as a steering movement to the wheels for steering.

In the case of the type of construction of a device mentioned in the introduction, the assistance force is coupled as an auxiliary torque into the steering shaft in addition to the manually input steering moment. Here, the auxiliary torque is generated by an electric motor which is driven by means of a controller in a manner dependent on the measured steering moment, the steering angle and/or further measurement variables. The motor shaft of the electric motor is connected rotationally conjointly, that is to say fixedly in terms of torque, to a gearwheel which, in a known type of construction, is for example in the form of a worm and meshes with a toothed wheel, which may correspondingly be in the form of a worm wheel and is attached rotationally conjointly to the steering shaft. The auxiliary torque can be introduced into the steering shaft by means of an arrangement of the gearwheel on the output shaft, on the input shaft or on the steering pinion in the steering gear.

For reliable operation with little wear, and in order to generate pleasant, harmonious steering feel, it is demanded in practice that the auxiliary torque be introduced in shock-free and jerk-free fashion into the steering system and also that no disturbing operating noises are generated. To realize this, it is known in the prior art to arrange a coupling element between the motor shaft and the gearwheel, for example the worm. To homogenize the introduction of torque and compensate undesired play, it is known for example from DE 10 2012 010 869 A1 to use, between the motor shaft and the worm, a coupling element which is in the form of a damping coupler and which comprises an inner and an outer rotor with a damping element formed from elastomer material arranged in between. In this way, a type of dog coupling is provided which allows the auxiliary torque to be coupled in a resilient, damped manner.

A disadvantage of the coupling element known in the prior art is the relatively complex construction composed of multiple functional components, which leads to high outlay in terms of manufacturing and costs. Furthermore, a relatively large structural space is taken up.

In the light of the problems discussed above, it is an object of the present invention, in the case of a device of the type mentioned in the introduction, to provide an improved coupling between electric motor and gearwheel with lower outlay in terms of production and costs.

### PRESENTATION OF THE INVENTION

To solve the problems mentioned above, it is proposed according to the invention that the coupling element comprises a torsionally elastic bar element which is torsionally more flexible than the motor shaft and the gearwheel.

The coaxially arranged bar element preferably forms a connecting shaft between the motor shaft and the gearwheel, for example a worm. A special feature according to the invention here is that the bar element is torsionally more flexible, that is to say is more elastic with respect to torsion, about its longitudinal axis than the motor shaft, and is likewise more elastic than the gearwheel. In other words, the spring element forms a torsion bar spring which, with regard to a rotation about its longitudinal axis, exhibits a lower spring stiffness, that is to say torsional stiffness, than the motor shaft and a lower torsional stiffness than the gearwheel. This has the effect that, during the transmission of an auxiliary torque, the motor shaft and the gearwheel remain undeformed, that is to say they are not inherently twisted, whereas the bar element is resiliently twisted in a manner dependent on the torque acting at its ends. Here, the expression “undeformed” is to be understood to mean that, in relation to the relatively large angle of twist of the bar element, the motor shaft and the gearwheel are elastically deformed only to a very small degree under the action of torque.

An advantage of the invention is that the coupling element can be realized by a single component, that is to say the bar element. Said bar element can be produced and installed with little outlay, wherein the comprehensive expert knowledge known from torsion bar springs can be utilized directly in the design and production process. Therefore, an adaptation of the coupling element with regard to the demanded elastic and other mechanical characteristics, for example strength, torsional and bending stiffness, spring characteristic curve, damping characteristics, vibration behavior and the like, can also be performed with little outlay. Expedient production costs can thereby be realized.

By virtue of the fact that the elastic characteristics such as spring constant and spring travel or spring angle can be predefined within wide limits by configuring the dimensions and material of the bar element, an optimized adaptation to the specific demands of the present usage situation as a torque-transmitting coupling element is possible. In this way, it is for example possible to provide an adequately large spring force in order to ensure quiet functioning with little wear under all encountered operating conditions.

A further advantage of the use, according to the invention, of a torsion bar spring as a coupling element is that a particularly small structural form can be realized in relation to other known types of spring and damping elements. By contrast to known spring arrangements, dog couplings or the like, it is specifically generally the case that the cross section or diameter will be smaller than that of the motor shaft or of the gearwheel or of the axle thereof. This results from the fact that the spring stiffness of a torsion bar with a circular cross section is proportional to d⁴ (d=diameter) and inversely proportional to the resilient length L. In the case of an installation length predefined by the available installation space, the cross section of the bar element can be easily calculated taking into consideration material strength, shear modulus and the torque to be transmitted.

The bar element transmits the auxiliary torque from the motor shaft to the gearwheel. Here, provision may preferably be made for an overload protection means to be provided between the motor shaft and the gearwheel, which overload protection means protects the bar element against destruction in the event of an exceedance of a limit torque. This may be realized by means of a loose form fit between the motor shaft and the gearwheel. Said form fit takes effect from the point at which the limit torque and the associated relative angle of twist between motor shaft and gearwheel are exceeded, such that the auxiliary torque is transmitted directly from the motor shaft to the gearwheel. The overload protection means may for example be realized by means of a profile with two flat sides on the motor shaft and a corresponding bore with two flat sides on the gearwheel, wherein these interact by means of a loose form fit. An advantage of the overload protection means is the associated increase in operational reliability.

The torsional stiffness of the bar element preferably amounts to between 5 Nm/° and 30 Nm/°.

An additional advantage results from the fact that the bar element is more elastic in terms of bending than the motor shaft and the gearwheel. Specifically, the bar element likewise comprises a predefined bending stiffness, which is the spring stiffness with respect to bending transversely with respect to its longitudinal extent. Here, the bar element exhibits a lower bending stiffness than the motor shaft and likewise a lower bending stiffness than the gearwheel or the axle thereof. The spring force exerted in a radial direction with respect to the steering shaft in the event of bending of the bar element can be utilized to push the gearwheel—for example the worm—resiliently against the toothed wheel—for example the worm wheel. For this purpose, an angle offset with respect to the common axis of motor shaft and gearwheel is predefined, such that the toothing of the gearwheel is preloaded in spring-loaded fashion in the direction of meshing engagement with the toothing of the toothed wheel. This permits meshing between gearwheel and toothed wheel without play by means of the coupling element alone, without the need for additional spring-loading or preloading devices as in the prior art. In this way, the number of components, the outlay in terms of manufacturing and assembly and thus the outlay in terms of costs can be reduced.

The free length of the bar element, which is the length between the clamping or fastening points at the gearwheel and toothed wheel and which is available for resilient torsion or bending, amounts to at least 2 mm, and in a preferred embodiment 5 mm. The free length particularly preferably comprises a value between 5 mm and 40 mm. An embodiment of the invention provides that the bar element comprises a smaller cross-sectional area and/or a lower torsional geometrical moment of inertia than the motor shaft and the gearwheel. In this way, it is possible to realize a particularly compact structural form, in particular also with regard to the fastening of the bar element to the motor shaft and to the gearwheel.

With regard to the elastic material that is used, the bar element may be manufactured from a material with a greater, equal or lower shear modulus in relation to the motor shaft and the gearwheel. For adaptation of the bar element to given boundary conditions such as structural space, torque to be transmitted, torsional and bending stiffness, spring characteristic curve, damping characteristics, vibration behavior etc., it may be expedient for the material of the bar element to be selected with regard to optimized functionality independently of the materials from which the motor shaft or the gearwheel are manufactured. For example, it is conceivable to use a material with a lower shear modulus in order to realize a softer spring action with sufficient material cross section, or a higher shear modulus in order to permit a smaller cross section or a smaller structural size.

It is furthermore advantageous that the bar element is connected to the motor shaft and/or to the gearwheel by means of a force-fitting and/or form-fitting and/or cohesive connection. A connection fixed in terms of torque must be produced between the motor shaft and the gearwheel in order to transmit the torque. For example, the bar element may be pressed or thermally shrink-fitted into an interference fit in order to form a force fit, or connecting elements in the form of a pinning or wedging configuration may be used. Alternatively, form-fitting connections with polygonal or non-circular connection elements which engage into one another may be realized, wherein an advantageous refinement is a so-called knurled connection. Here, the bar element and/or a corresponding receiving bore in the motor shaft or in the gearwheel are/is equipped with an axial longitudinal toothing which, during the pressing-in process, digs with plastic deformation into the corresponding joining surface of the connecting partner. In this way, a particularly durable force fit and form fit can be formed. It is furthermore also conceivable and possible for a rolled configuration in the form of a transverse knurl or a longitudinal knurl to be provided on the bar element and for said bar element to be pressed into a circular cylindrical receiving bore. A longitudinal knurl or a transverse knurl may advantageously be formed into the receiving bore. A cohesive connection may alternatively or additionally be generated, for example by adhesive bonding, welding by friction, ultrasound or laser welding methods, or the like. From the connecting methods known for the clamping of a torsion bar in the prior art, it is basically possible to select the joining technique that best meets the requirements.

In an advantageous embodiment of the invention, the bar element is formed integrally with the motor shaft and/or with the gearwheel. Here, an integrated component is formed, wherein the bar element and the motor shaft, or the bar element and the gearwheel, for example a worm, or the bar element and the motor shaft and the gearwheel are manufactured from a single piece of the same material. As material, use may for example be made of steel, from which said integrated bar element is produced by non-cutting and/or cutting machining processes. Said material may comprise a hardness which is continuously homogeneous over its individual functional regions, or else may comprise regions of different hardnesses. It is thus for example conceivable for regions with different characteristics to be formed by partial hardening, for example for a particularly durable surface of the worm to be realized. The partial hardening may for example be performed inductively. For this purpose, it is likewise conceivable for specially adapted surface structure or surface coatings, for example titanium nitride, silicon carbide, boron carbide or the like, to be applied to the entire integral component or to parts thereof, in order to improve the sliding characteristics and/or durability.

The gearwheel is preferably in the form of a worm, and the toothed wheel is preferably in the form of a worm wheel. This is a proven embodiment of a gear for introducing an auxiliary torque, in the case of which, according to the invention, the worm is connected to the motor shaft by means of a bar element, that is to say a torsionally elastic torsion bar. In this way, a torque can be coupled in jerk-free and shock-free fashion. Furthermore, owing to its elastic characteristics in terms of bending, the torsion bar can be used to push the worm into meshing engagement with the worm wheel. This may be easily realized by virtue of an angle offset being predefined between the axis of rotation of the motor shaft and the axis of rotation of the worm, such that the bar element is elastically bent. The restoring force that arises here ensures that the worm thread turns of the worm mesh with the toothing of the worm wheel without play. This promotes improved running smoothness and reduced wear.

### DESCRIPTION OF THE DRAWINGS

Advantageous embodiments of the invention will be discussed in more detail below on the basis of the drawings, in which, in detail:

FIG. 1 shows a schematic perspective illustration of a steering system of a motor vehicle with a power assistance means;

FIG. 2 shows a schematic perspective view of a device according to the invention for introducing an auxiliary torque, in a partially disassembled state;

FIG. 3 shows a schematic sectional view through a device as per FIG. 2 in a first embodiment;

FIG. 4 shows a schematic sectional view through a device as per FIG. 2 in a second embodiment;

FIG. 5 shows a schematic sectional view through a device as per FIG. 2 in a third embodiment;

FIG. 6 shows a perspective view of an assembly designed according to the invention comprising motor shaft, coupling element and worm.

### EMBODIMENTS OF THE INVENTION

In the various figures, identical parts are always denoted by the same reference designations and will therefore generally each also be mentioned only once.

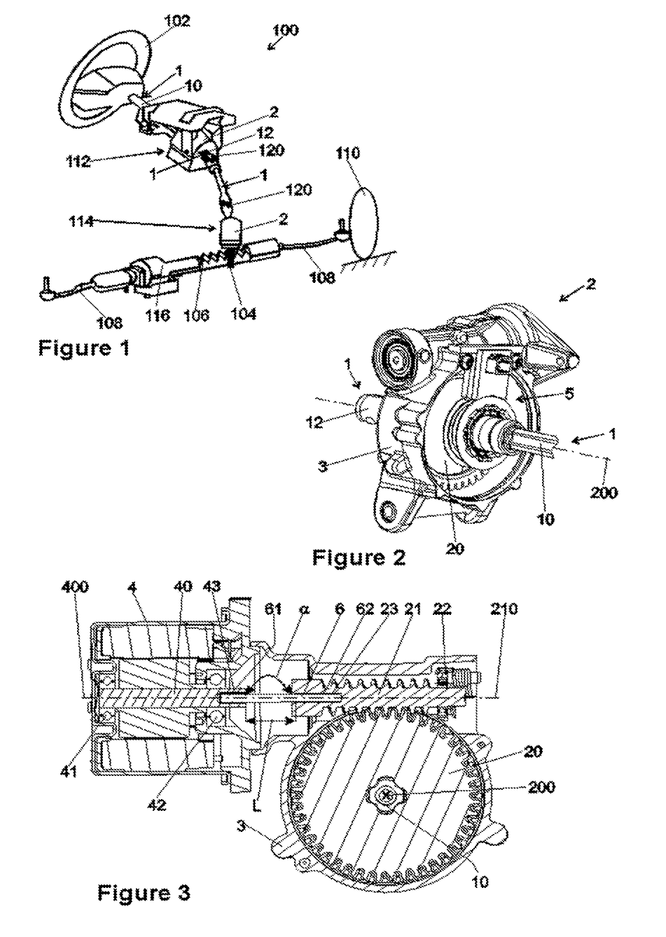

FIG. 1 schematically illustrates a motor vehicle steering system 100 which comprises a steering shaft 1. To the input shaft 10 of the steering shaft 1 there is attached a steering wheel 102 by means of which a driver can input a steering torque—also referred to for short as steering moment—as a steering command into the steering shaft 1. The steering moment is transmitted via the steering shaft 1 to a steering pinion 104 which meshes with a toothed rack 106, which then in turn, by means of a displacement of the track bars 108, transmits the predefined steering angle to the steerable wheels 110 of the motor vehicle.

An electric power assistance means may be provided as a power assistance means 112 coupled at an input side to the steering shaft 1 and/or a power assistance means 114 coupled to the steering shaft 1 at the pinion 104 and/or a power assistance means 106 coupled to the toothed rack 106. The power assistance means 112 or 114 comprise in each case a device 2 for introducing an auxiliary torque into the steering shaft 1, by means of which device an auxiliary torque or an additional steering angle can be coupled into the steering shaft 1 or the steering pinion 104, whereby the driver is assisted with regard to steering work. The assistance may likewise be realized by means of a power assistance means 116, by means of which a linear auxiliary force can be introduced into the track bar 108 via the toothed rack 106. The three different power assistance means 112, 114 and 116 illustrated in FIG. 1 show possible positions for the arrangement thereof.

Normally, only a single one of the positions shown is occupied by a power assistance means 112, 114 or 116. The auxiliary torque or the auxiliary force which is to be imparted by means of the respective power assistance means 112, 114 or 116 in order to assist the driver is determined taking into consideration a steering moment input by the driver and detected by a torque sensor. A torque sensor of said type is normally integrated in a power assistance means 112 or 114 together with a device 2 and is not illustrated in detail here.

To briefly summarize, in the torque sensor, the input shaft 10 and an output shaft 12 are coupled to one another in rotational elastic fashion by means of a torsion bar. Thus, a steering moment input into the input shaft 10 by a driver via the steering wheel 102 leads to a relative rotation of the input shaft 10 with respect to the output shaft 12 if the output shaft 12 does not rotate exactly synchronously with respect to the input shaft 10. Said relative rotation between input shaft 10 and output shaft 12 may be measured by means of a rotational angle sensor, and a corresponding input torque relative to the output shaft 12 can be determined on the basis of the known torsional stiffness of the torsion bar. In this way, the torque is determined by means of the measurement of the relative twist between input shaft 10 and output shaft 12. A torque sensor of said type is known in principle and may be realized for example by means of an electromagnetic sensor arrangement or some other measurement of the relative rotation.

Correspondingly, on the basis of the measured steering moment which is imparted by the driver to the steering shaft 1 or to the input shaft 10 via the steering wheel 102, an auxiliary torque is calculated which is introduced into the steering shaft by means of a device 2 in one of the power assistance means 112 or 114.

Alternatively or in combination with the introduction of the auxiliary torque, the power assistance means 112, 114, 116 can introduce an additional steering angle into the steering system, which additional steering angle is added to the steering angle imparted by the driver via the steering wheel 102.

The steering shaft 1 in FIG. 1 furthermore comprises at least one, preferably two, cardanic joint(s) 120, by means of which the profile of the steering shaft 1 in the motor vehicle can be adapted to the spatial conditions.

FIG. 2 shows a device 2 partially in a perspective view, wherein, for a better overview, the axial housing cover on the side facing toward the viewer has been omitted. A gearwheel in the form of a worm wheel 20 is attached rotationally conjointly to the steering shaft 1, more specifically to the output shaft 12, coaxially with respect to the steering shaft axis 200, which thus also forms the worm wheel axis. By means of a rotation of the worm wheel 20 about the worm wheel axis 200, an auxiliary torque can be introduced into the steering shaft 1 in order to correspondingly introduce an auxiliary force or an additional steering angle into the steering train. The worm wheel 20 is arranged in a housing 3. By means of a sensor arrangement 5, for example a magnetic sensor arrangement, the twist of the input shaft 10 relative to the output shaft 12 can be measured, and from this, the steering torque input into the steering wheel 102 by the driver can be determined.

FIG. 3 illustrates a section perpendicular to the steering shaft axis 200 (worm wheel axis) through a device 2 as per FIG. 2 in a first embodiment through the worm wheel 20. From this, it can be seen how a worm 21, the worm axis 210 of which lies transversely with respect to the worm wheel axis 200, is in meshing engagement with the worm wheel 20. The worm 20 is mounted in a bearing device 22, so as to be rotatable about the worm axis 210, in the housing 3.

An electric motor 4 is flange-mounted on the housing 3, which electric motor comprises a motor shaft 40 which can be driven in rotation about its motor shaft axis 400. The motor shaft is mounted in rolling bearings 41, 42.

The motor shaft 40 is connected fixedly in terms of torque to the worm 21 by means of a coupling element, specifically a torsional elastic bar element 6 according to the invention. The bar element 6 forms a torsional elastic torsion bar with a free length L, which is the length between the clamping or fastening points at the motor shaft 40 and worm 21, and over said free length L, said torsion bar exhibits lower torsional stiffness than the motor shaft 40 and the worm 21. The free length L may preferably be greater than 2 mm, and a length L of approximately 5 mm is advantageous.

FIG. 3 shows a first embodiment in which the motor shaft 40, the bar element 6 and the worm 21 have initially been manufactured as separate parts and have subsequently been rotationally conjointly joined together axially with respect to the axis of rotation 400 or 210. For this purpose, in the output-side end of the motor shaft 40, there is formed a coaxial bore 43 into which a first end region 61 of the bar element 6 is rotationally conjointly inserted. The second end region 62 of the bar element 6 is inserted likewise rotationally conjointly into a coaxial bore 23 in the motor-side end of the worm 21.

The end regions 61, 62 of the bar element 6 may be pressed with an oversize into the bores 43, 23, such that a force-fitting connection is formed. It is likewise possible for the end regions 61, 62 and, correspondingly thereto, the bores 43, 23 to be provided with a non-circular cross section, for example a polygon, such that a form fit is formed with respect to a rotation about the axis 400, 210. A further possibility for generating a durable connection which is fixed in terms of torque consists in equipping the end regions 61, 62 of the bar element and/or the bores 43, 23 with a longitudinal toothing which, during the axial pressing-in process, digs into the joining surface of the connecting partner with plastic deformation. In this way, a particularly durable force fit and form fit can be formed. A cohesive connection may alternatively or additionally be generated, for example by adhesive bonding by introduction of adhesive, welding by friction, ultrasound or laser welding methods, or the like. The use of additional connecting elements such as pins, feather keys, wedges or the like is basically likewise conceivable.

The formation of the bar element 6 as an initially separate component has the advantage that the material can be freely selected, for example with a greater or lower shear modulus or other material characteristics which differ from those of the motor shaft 40 or of the worm 21.

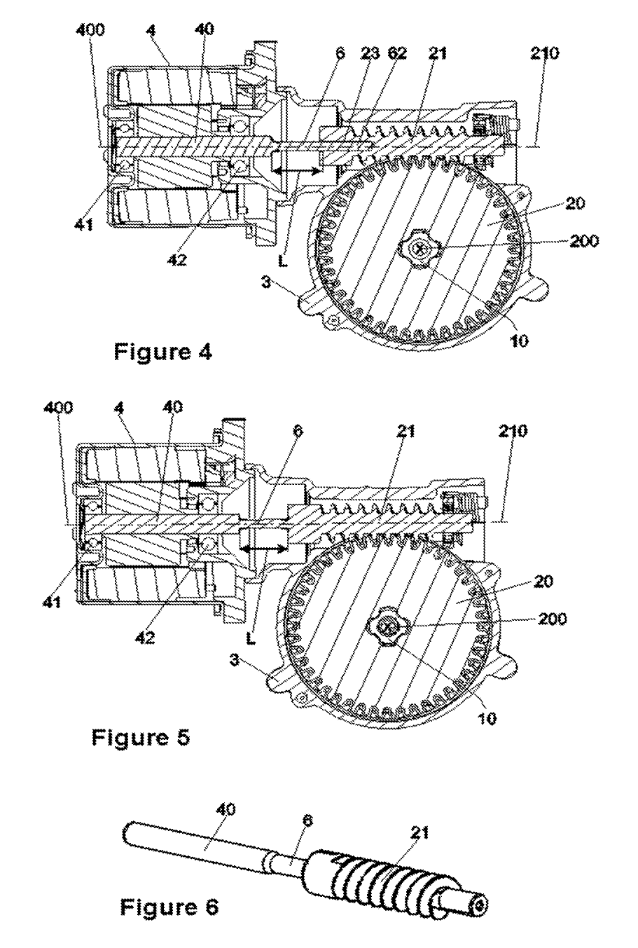

In an alternative embodiment shown in FIG. 4, the motor shaft 40 is formed integrally, that is to say is manufactured from one material piece, with the bar element 6. The motor shaft 40, which is normally composed of steel, can thus transition at the output side into a section of relatively small diameter, which forms the bar element 6. Such a shape of a motor shaft 40 can be manufactured particularly economically, for example by virtue of the cross section of the section which forms the bar element 6 being reduced in non-cutting fashion by pressing or rolling until the desired torsional stiffness, which is lower than that of the motor shaft 40, is attained. On the free end region 62 there may likewise easily be formed a longitudinal toothing which permits a force-fitting and form-fitting connection to the worm 21 by means of an axial pressing-in movement, which is easy to perform.

A further alternative embodiment is illustrated in FIG. 5, in which the motor shaft 40 is formed integrally, that is to say is formed from one material piece, together with the bar element 6 and the worm 21. In this way, a single integral component is formed which requires no joining connections and can be produced economically. In this embodiment, the elastic characteristics of the bar element 6 can be influenced by means of the dimensions and shaping thereof. It is furthermore conceivable, if steel is used as material, for the individual functional regions of motor shaft 40, bar element 6 and worm 21 to be equipped with different material characteristics such as strength, hardness or the like by means of partial thermal treatment. It is likewise possible for the functionality of the individual regions to be adapted to the set requirements by means of a surface treatment, for example a hard material coating or the like.

FIG. 6 shows an assembly formed from a motor shaft 40, a bar element 6 and a worm 21, wherein the type of construction as per FIG. 3, FIG. 4 or FIG. 5 may be realized.

In the illustrated embodiments, the worm axis 210 and the motor shaft axis 400 are in alignment with one another, that is to say, in the section plane illustrated, they enclose an angle α of 180°. It is however also conceivable for the motor 4 to be arranged in angularly offset fashion, such that an angle α of less than 180° is enclosed between the motor shaft axis 400 and the worm axis 210. In this way, the bar element 6 is bent, that is to say preloaded into a bent state, over its free length L, wherein the bending moment that arises is absorbed via the worm 21 radially against the toothing of the worm wheel 20. In other words, the worm 21 is pushed with its worm thread turns into meshing engagement with the worm wheel 20. This yields play-free meshing and a high degree of running smoothness during the introduction of an auxiliary torque.

### LIST OF REFERENCE DESIGNATIONS

1 Steering shaft

10 Input shaft

12 Output shaft

100 Motor vehicle steering system

102 Steering wheel

104 Steering pinion

106 Toothed rack

108 Track bar

110 Steerable wheel

112 Power assistance means

114 Power assistance means

116 Power assistance means

120 Cardanic joint

2 Device for introducing an auxiliary torque

20 Worm wheel

200 Worm wheel axis

21 Worm

210 Worm axis

22 Bearing device

23 Bore

4 Electric motor

40 Motor shaft

400 Motor shaft axis

41 Bearing

42 Bearing

43 Bore

5 Sensor arrangement

6 Bar element

61 End region

62 End region

1.-9. (canceled)

10. A device for introducing an auxiliary torque into a steering shaft of an electromechanical power-assisted steering system, the device comprising:
an electric motor that comprises a motor shaft;
a gearwheel;
a coupling element that fixedly couples with respect to torque the motor shaft to the gearwheel, wherein the coupling element comprises a torsional elastic bar that is torsionally more flexible than the motor shaft and the gearwheel; and
a toothed wheel that meshes with the gearwheel, wherein the toothed wheel is disposed rotationally conjointly on the steering shaft.

11. The device of claim 10 wherein a torsional stiffness of the torsional elastic bar is between 5 Nm/° and 30 Nm/°.

12. The device of claim 10 wherein a free length of the torsional elastic bar is at least 2 mm.

13. The device of claim 10 wherein a free length of the torsional elastic bar is at least 5 mm.

14. The device of claim 10 wherein the torsional elastic bar is more elastic with respect to bending than the motor shaft and the gearwheel.

15. The device of claim 10 wherein the torsional elastic bar has at least one of a smaller cross-sectional area or a lower torsional geometrical moment of inertia than the motor shaft and the gearwheel.

16. The device of claim 10 wherein the torsional elastic bar comprises a material with a greater shear modulus than the motor shaft and the gearwheel.

17. The device of claim 10 wherein the torsional elastic bar comprises a material with a lower shear modulus than the motor shaft and the gearwheel.

18. The device of claim 10 wherein the torsional elastic bar and the motor shaft have equal shear moduli.

19. The device of claim 10 wherein the torsional elastic bar is connected to at least one of the motor shaft or the gearwheel by way of a connection that is at least one of force-fitting, form-fitting, or cohesive.

20. The device of claim 10 wherein the torsional elastic bar is integral with at least one of the motor shaft or the gearwheel.

21. The device of claim 10 wherein the gearwheel is configured as a worm, wherein the toothed wheel is configured as a worm wheel.
